(19) United States
(12) Patent Application Publication
(10) Pub. No.: US 2022/0071223 A1
(43) Pub. Date: Mar. 10, 2022

(54) Puffed Cheese Product and Method

(71) Applicant: Glanbia Nutritionals Ltd., Kilkenny (IE)

(72) Inventors: Emily Stout, Twin Falls, ID (US); Maren Clark Long, Pasadena, CA (US)

(21) Appl. No.: 17/325,201

(22) Filed: May 19, 2021

Related U.S. Application Data
(60) Provisional application No. 63/026,980, filed on May 19, 2020.

(51) Int. Cl. A23C 19/09; A23P 30/36; A23C 19/086; A23C 19/068; A23C 19/097

(52) U.S. Cl. CPC A23C 19/0912; A23P 30/36; A23C 19/097; A23C 19/068; A23C 19/086

(57) ABSTRACT

Disclosed is a method for producing crispy, puffed cheese snacks made entirely of, or primarily of, cheese. The method uses a sequential process to produce cheese snacks with excellent taste, smoother surface and mouthfeel, delicate crunch, and minimal breakage during packaging and shipping. The method can also be used to produce cheese powders.

### FIELD OF THE INVENTION

The invention relates to puffed cheese products. More specifically, the invention relates to methods for making crispy puffed cheese products and products made by those methods.

### BACKGROUND OF THE INVENTION

In the snack food industry, the terms “cheese puff” and “puffed cheese snack” generally bring to mind products that are made of ground corn or cornmeal and covered with cheese powder and/or cheese-flavored powder. For example, one of the most popular brands on the market is the Cheetos® brand, which includes a variety of puffed cheese snacks that are baked or fried. Those types of products can be manufactured by extruding heated corn dough through a die that forms the product into a desired shape. Starting with cornmeal, water is added to produce a cornmeal/water mixture that is like a thick paste. The cornmeal/water mixture is fed through an extruder, where an auger pushes the mixture through a die as it is exposed to high pressure, thereby developing the proper temperature to convert the moisture in the cornmeal paste into steam, creating air cells in the cornmeal paste and producing the corn puff. Corn puffs made this way can be fried or baked to remove moisture and to give them the desired texture and crispiness, as well as coated with cheese powder, cheese-flavored powder, etc., to produce what has traditionally been known as a “cheese puff.”

Cheese puffs made with cornmeal can readily be mass-produced, packaged, and shipped to provide bite-sized snacks with minimal breakage or crumbling and reasonable shelf-life, making them a mainstay of the snack food market. Examples of ingredients used in three commercially-available puffed cheese products using a carbohydrate base are shown in Table 1.

TABLE 1
Commercial Puffed Cheese Products

| Product | Ingredients |
|---|---|
| Cheetos ® Natural | Organic corn meal, expeller-pressed sunflower oil, |
| White Cheddar Puffs | whey, cheddar cheese, maltodextrin, sea salt, |
| | natural flavors, disodium phosphate, sour cream, |
| | torula yeast, lactic acid, and citric acid. |
| Utz ® Cheese Balls, | Corn meal, vegetable oil, whey, maltodextrin, |
| Cheddar | cheddar cheese, milkfat, whey protein concentrate, |
| | salt mono and diglycerides, buttermilk solids, natural |
| | flavor, disodium phosphate, lactic acid, yellow #6, |
| | autolyzed yeast extract, yellow #5, disodium |
| | inosinate, disodium guanylate, artificial flavor. |
| Golden Flake ® | Enriched corn meal, vegetable oil, whey, |
| Cheese Curls | maltodextrin, cheddar cheese, milkfat, salt, whey |
| | protein concentrate, monosodium glutamate, |
| | buttermilk solids, natural flavor, sodium phosphate, |
| | lactic acid, yellow #6, autolyzed yeast extract, |
| | yellow #5, disodium inosinate, disodium guanylate, |
| | artificial flavor, beta carotene. |

The snack market has, however, been significantly impacted by both the increased focus on “clean label” products (natural, familiar, simple ingredients—as well as fewer ingredients, where possible) and the popularity of the low carbohydrate/higher fat ketogenic diet (the “keto diet”). In response, new products have been produced using limited ingredients. Some are made solely of cheese. Brands such as Cello Whisps®, Mrs. Cubbison's® Parmesan Crisps, Sonoma Creamery® Pepper Jack Crisps, etc., are cheese products similar to the crispy form of Italian frico. Traditionally, these have made by baking or frying mounds of finely-shredded cheese. When making frico, sheets of crispy cheese (which can be shaped while still warm into rolls, baskets, or other shapes that become crisp when cooled) can be made by using larger amounts of cheese, while smaller amounts of cheese baked or fried in mounds will generally produce wafers or crisps. Commercial cheese crisps like Whisps® generally comprise the smaller, wafer-like crispy products.

Carbohydrate-based puffed snacks, such as the very popular Cheetos® brand snacks covered in cheese powder, offer some advantages over the typical crispy wafer made solely of cheese. Although the cheese wafer is clean-label and generally a better option for keto snacking, carbohydrate-based cheese puffs generally survive shipping and storage better than the more friable cheese wafers, packages of which can contain a significant percentage of wafer crumbs. By making the cheese snacks thick enough to decrease breakage, formulators risk creating products that are viewed by consumers as too hard, rather than delicately crunchy. Another advantage that the cheese-flavored carbohydrate-based puffed snacks provide lies in the fact that cheese powder is typically added to the cooling puffs and not further heat-processed, reducing the opportunity for additional browning reactions in the cheese.

Under high heat, cheese can brown as the result of carbon atoms from reducing sugars combining with nearby amino acids (Maillard reactions). While this can produce improved flavor up to a point, excessive browning of cheese produces bitterness. Furthermore, in low-fat dairy products, Maillard reactions can produce off-flavors. Maillard browning tends to occur at high temperatures, and the reaction peaks at a water activity (a_{w}) of about 0.6 to 0.7.

Puffs made solely of cheese are commercially available, using a process known as “radiant energy under vacuum,” a form of vacuum microwave dehydration. A commercial product is sold under the product name Moon Cheese®, a crispy snack item with holes at the surface that resemble craters. The process by which it is made relies on the application of a vacuum sufficient to promote cooking/dehydration at room temperatures in order to avoid melting the cheese as the product is heated. The process generally occurs in a drum, the rotation of the drum ultimately producing the round-to-oblong shape of the bite-size pieces.

Consumer preferences drive the success or failure of products, and cheese snack development has been targeted to address those preferences. Cheese snacks should taste like cheese and the color should closely resemble the color of the cheese(s) from which they are made. They are generally more acceptable if they are crispy and crunchy without being hard and brittle, lack an oily mouthfeel, do not significantly pack into the crevices in an around the teeth as they are chewed (little to no “toothpick”), have a pleasant cheesy taste, and can be packaged and shipped without significant product breakage resulting in broken snack pieces, fines, etc. However, cheese generally contains a significant amount of oil/fat, presenting challenges for producing cheese snack products that are crispy without being overcooked, burning or browning excessively, or tasting rancid or oxidized. Table 2 lists some of the negative properties noted during a survey of fourteen commercially-available products.

TABLE 2
Challenges to Cheese-Only Crisps/Puffs Manufacture

| | Negatives Encountered in Cheese Crisp or Puff |
|---|---|
| Property | Production |
| Taste | Oxidized taste, oily taste, rancid oil taste, |
| | “cardboard” taste, strong acid (e.g., butyric) taste, |
| | taste not specifically identifiable as cheese. |
| Texture/Hardness | Brittle (rather than crispy), hard, scratchy, rough |
| | edges (can irritate mouth) |
| Color | Unappetizing overall brown color, brown edges |
| General | Oily mouthfeel, high degree of toothpack, |
| | craters/lack of smoothness at surface, texture |
| | irritating to tongue and mouth |

What are needed are new and better ways to produce crispy snacks made solely of cheese (or primarily of cheese) have good texture, non-greasy mouthfeel, lack rancidity over a reasonable shelf-life, and remain intact during shipping. It would provide even more of a bonus if the crispy cheese snacks could have smoother surface texture than those presently on the market, and could be produced in defined, controlled shapes.

### SUMMARY OF THE INVENTION

The invention provides a method for making puffed cheese snacks, the method comprising the steps of forming at least one cheese into cheese pieces having a thickness of from about 0.5 mm to about 3 inches, dehydrating the cheese pieces to produce a dehydration gradient in the cheese pieces, and heating the dehydrated cheese pieces using dielectric heating to puff the cheese pieces, thereby forming cheese puffs. In various aspects of the method, the cheese pieces can comprise at least one shape selected from the group consisting of animal shapes, stars, shapes of commonly identifiable objects, cubes, cuboids, spheres, ellipsoids, cylinders, cones, triangular prisms, hexagonal prisms, triangular-based pyramids, hexagonal pyramids, pentagrammic prisms, icosahedrons, octahedrons, dodecahedrons, and combinations thereof. In various aspects of the method, the dielectric heating step can optionally be performed in a negative pressure environment. In various aspects of the method, the cheese pieces can have a thickness of from about 0.5 mm to about 1 inch.

In its various aspects, the method can be used to make cheese puffs from at least one cheese selected from the group consisting of full, partial, and low-fat natural cheeses, including varieties such as, for example, Cheddar, Colby, Monterrey Jack, Provolone, Mozzarella, Gouda, Swiss, Havarti, etc. Combinations thereof (i.e., combinations of two or more cheeses) can also be used to produce cheese puffs by the method of the invention. In various aspects, the cheese puffs can also comprise inclusions and/or coatings such as vegetable powders, seasoning blends, herbs, and/or peppers.

In various aspects of the method, the step of dehydrating can be performed at or above standard room temperature. In other aspects of the method, the step of dehydrating can be performed by convection heating at temperatures of from about 80 degrees Fahrenheit to about 170 degrees Fahrenheit (e.g., in a standard or commercial convection oven, for example). In various aspects of the invention, the dielectric heating step can be performed using a method selected from the group consisting of microwave heating, radio frequency (RF) heating, and combinations thereof.

The invention also provides a method for making puffed cheese snacks comprising the steps of forming at least one cheese into cheese pieces having a thickness of from about 0.5mm to about 3 inches, dehydrating the pieces of cheese by air-drying at a dehydration temperature of from about 65 to about 170 degrees Fahrenheit for a time period of from about 10 minutes to about 8 hours, and puffing the dehydrated cheese pieces using dielectric heating to form cheese puffs. In various aspects, the dehydration temperature is from about 80 degrees Fahrenheit to about 170 degrees Fahrenheit, which includes temperature ranges falling within that range (e.g., from about 100 to about 150 degrees Fahrenheit, from about 90 to about 170 degrees Fahrenheit, etc.). In various aspects, the dehydration temperature is from about 90 to about 150 degrees Fahrenheit.

In an additional embodiment, the invention provides a method for making puffed cheese snacks comprising the steps of forming at least one cheese into cheese pieces having a thickness of from about 0.5mm to about 3 inches, dehydrating the pieces of cheese by holding the cheese at room temperature for a time period of from about 4 hours to about 4 days, and puffing the dehydrated cheese pieces using dielectric (e.g., microwave, radio frequency) heating to form cheese puffs.

### BRIEF DESCRIPTION OF THE DRAWINGS

FIG. 1 is a photograph of cheese puffs made by the method of the invention.

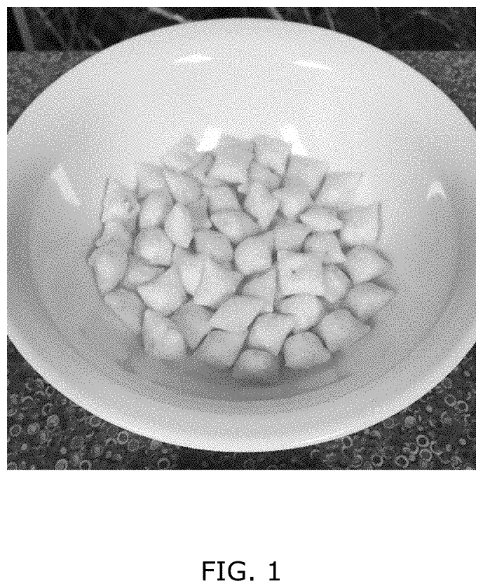

FIG. 2a is a photograph of cheese puffs made with reduced fat cheese, without the dehydration step, microwaved for 1 minute. FIG. 2b is a photograph of cheese puffs made with reduced fat cheese dried for 4 hours at 131 degrees Fahrenheit and microwaved for 1 minute. The lighter nature of the puffed product produced using microwave heating in combination with dehydration to produce a thicker outer skin is evident by comparison of the two products.

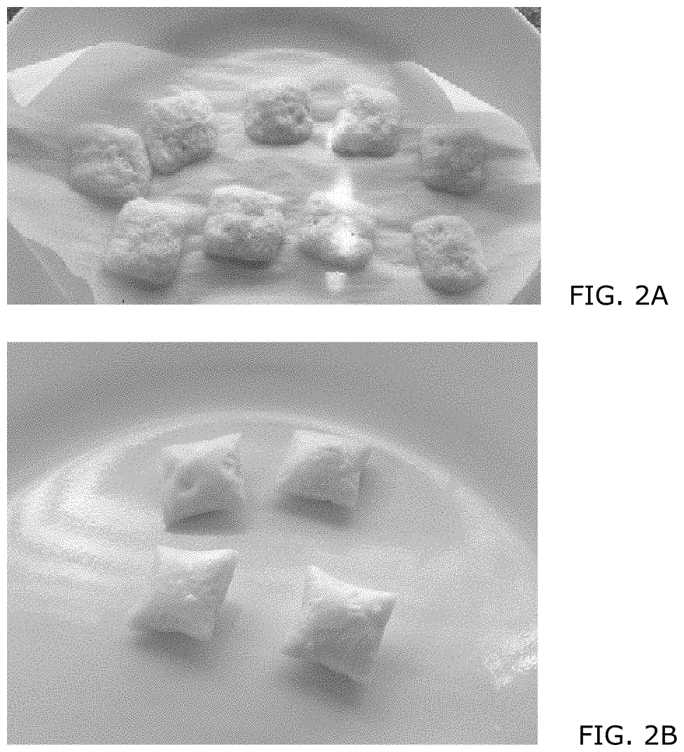

FIG. 3 is a photograph of cheese puffs made by the method of the invention, resembling tortilla chips, and having similar functionality.

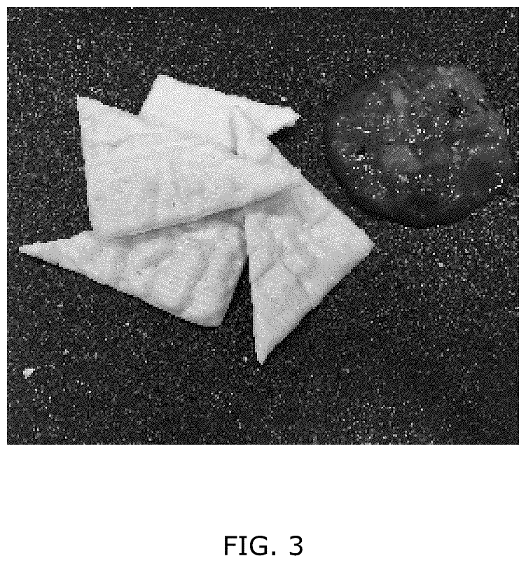

FIG. 4 is a photograph of cheese puffs made by the method of the invention, resembling the heads and ears of bears. The puffs generally retain the shape of the original cheese pieces and are not “disfigured” by large bubbles, holes, craters, etc.

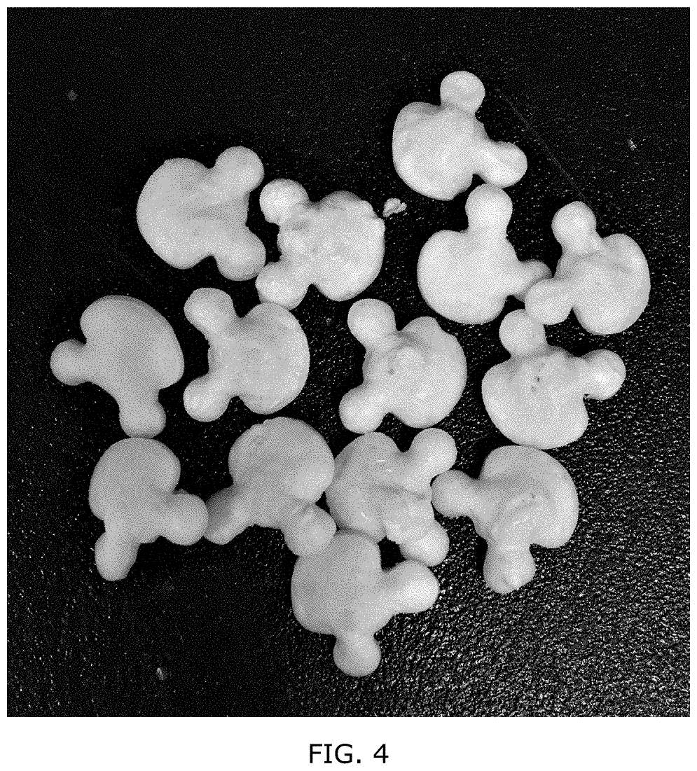

FIG. 5 is a photograph of cheese puffs made by the method of the invention, resembling fish that most people recognize as goldfish. Again, the puffs generally retain the shape of the original cheese pieces and are not “disfigured” by large bubbles, holes, craters, etc.

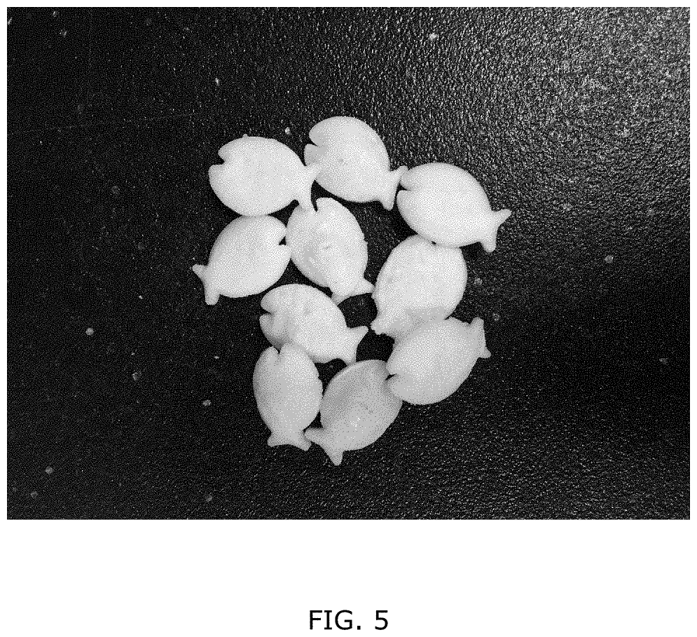

FIG. 6 is a photograph of cheese puffs made by the method of the invention, cut into star shapes. The puffs generally retain the shape of the original cheese pieces, even though star-shaped puffs made by conventional means would be more likely to be deformed during a popping or puffing process.

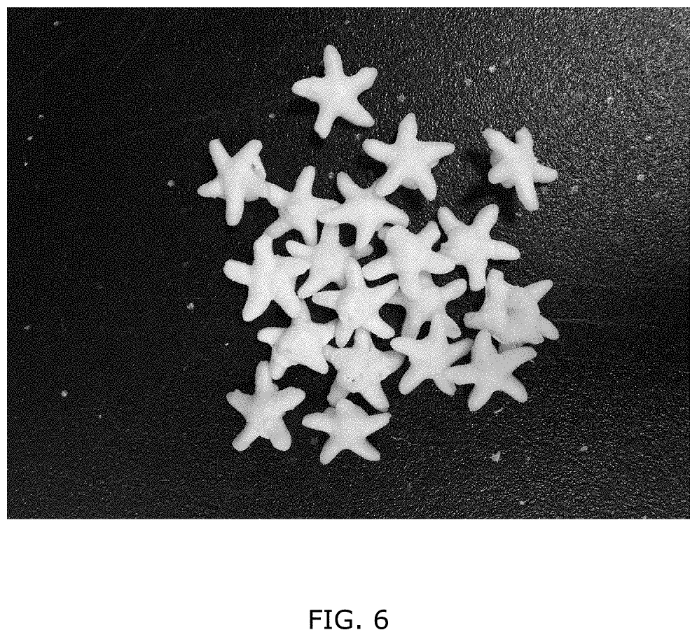

FIG. 7 is a photograph of a cross-section of cheese puffs made by the method of the invention. Lines have been added to indicate the edges of holes in three of the cross-sectional puffs. The exterior surface is smooth, while the interior is appropriately filled with holes created by air bubbles, producing a delicate crunch. The smoothness of the surface in a cheese snack made by the present method reduces the potential for surface deformation, which is particularly important when cheese snacks of varying predetermined shapes are desired—e.g., stars, alphabet letters, fruit shapes, etc.

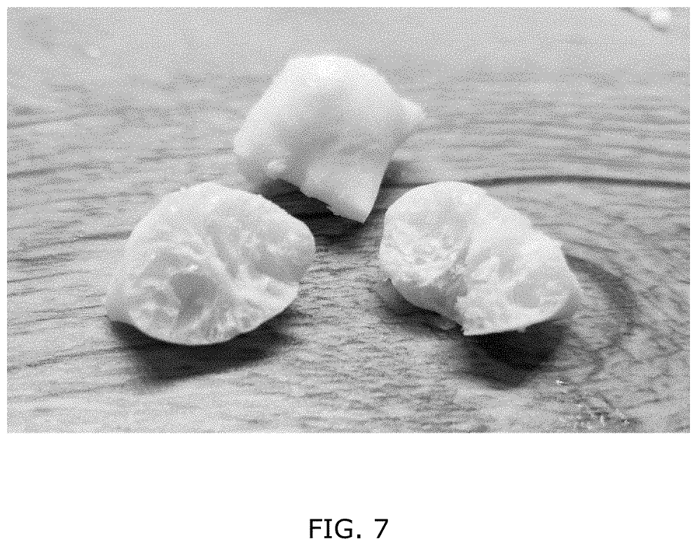

### DETAILED DESCRIPTION

The inventors have developed a new method for producing crispy, puffed cheese snacks made entirely of cheese, substantially of cheese, etc. The method does not require the use of custom-made equipment or facilities, and produces cheese snacks with excellent cheese taste or a more neutral taste that can be used as a base to create protein-based flavored snacks such as potato-flavored snacks, snack pieces with a smoother surface and mouthfeel, and minimal breakage during packaging and shipping. Furthermore, puffed cheese snacks made by the method of the invention have a lighter crunch, more similar to that of commercially-available carbohydrate-based cheese snacks than to that of currently commercially-available cheese snacks made almost entirely of cheese.

The method of the invention uses a sequential combination of dehydration and dielectric (e.g., microwave) heating to produce puffed cheese snacks. A milling step can also be added to the end of this process to create clean-label cheese powder from the cheese puffs that are generated. For example, a combination dehydration/microwave process for creating a puff is an alternative and innovative method of removing water from cheese, water removal being a critical step when producing cheese powder. Using this process to create a cheese powder eliminates the need to create a cheese slurry, eliminates the need for emulsifying salts, and can be a much more energy-efficient process than spray-drying.

That method also comprises the steps of forming at least one cheese into pieces of smallest dimension of from about 0.5 mm to about 3 inches, dehydrating the cheese pieces using convection heat to form dehydrated cheese pieces, the dehydrated cheese pieces having a water activity of from about 0.30 to about 0.95, and puffing the dehydrated cheese pieces using microwave heating to form cheese puffs. In various aspects of the method, the cheese pieces can comprise at least one shape selected from the group consisting of animal shapes, stars, shapes of commonly identifiable objects, cubes, cuboids, spheres, ellipsoids, cylinders, cones, triangular prisms, hexagonal prisms, triangular-based pyramids, hexagonal pyramids, pentagrammic prisms, icosahedrons, octahedrons, dodecahedrons, and combinations thereof. In various aspects of the method, the step of puffing the dehydrated cheese pieces can optionally be performed in a negative pressure environment.

One method by which shaped pieces can be made is the method of extrusion. One shaped extruded product that is immediately recognizable by consumers is the Goldfish® snack cracker, for example. Extrusion offers the option of relatively continuous production of shaped cheese pieces, which can then be transported to a convection oven, for example, for the first phase of the process, forming the “skin” on the surface of the piece of cheese. Extrusion dies can be made in a variety of shapes, and the die can readily be removed and replaced when it is desirable to start a new batch of cheese pieces having a different shape. Extrusion also offers the option of admixing different cheeses to form cheese pieces which incorporate two or more cheeses, and more easily incorporating into cheese pieces various inclusions that might be appropriate as components of the resulting puffed cheese snacks.

In the industry, reduction of large blocks of cheese, generally, by shredding or slicing, is known as “conversion.” A number of commercially-available devices offer (e.g., EQSpecial AutoCuber, Urschel Affinity®) options for converting cheese to shapes suitable for the formation of puffed cheese snacks. For example, pillow-shaped puffed cheese snacks can be made using slices of cheese, with pieces approximately the length and width of a postage stamp, for example, providing excellent results.

The term “thickness” is defined as the smallest dimension among length, width, and height. Sheets can be formed having a length and width of several centimeters or several inches, for example, while the height would generally be within the range of from about 0.5 mm to about 3 inches. This would therefore be considered the “thickness” of the sheets of cheese. This would allow for a puff to be produced in the shape of something as familiar as a tortilla, or a tortilla shell. Tubes, for example, could also be formed of such sheets wrapped around a material suitable for use producing the requisite amount of dehydration to maintain the shape of the piece of cheese during dielectric (e.g., microwave) heating/puffing. Puffs having a length and width similar to that of a potato chip, for example, could be produced from cheese pieces having a height of from about 0.5 mm to about 3 inches—the height being the smallest dimension, and therefore the thickness, of the cheese pieces.

Dehydration is defined herein as air-drying, which can be performed with, or without, added heat. To increase dehydration efficiency, heat may be added, which can be done, for example, by using a device such as an oven, a convection oven, etc. Dehydration is performed to produce a moisture gradient, with more moisture in the interior of the cheese piece and less at the surface—to produce a “skin” on the surface of the cheese piece. The step of dehydrating the cheese pieces therefore produces cheese pieces with a moisture gradient which decreases from the inside to the outside of the cheese pieces, and a resulting skin covering the surface of each cheese piece. Dehydration to produce such a moisture gradient to form the skin on the surface of the cheese piece generally provides improved results if performed as a two-stage process, with stage 1 being the initial skin formation at lower temperatures and frequent handling so that an even skin develops on the surface of the cheese pieces so that they do not stick together, and stage 2 being the final dehydration wherein, a sufficient skin having been formed in stage 1, the pieces undergo further dehydration to achieve target moistures, water activities, and skin thicknesses. Stage 2 can be performed at higher temperatures and product remains free-flowing despite not being frequently handled. (“Handling” generally refers to the process of agitating, tumbling, tossing, etc., to keep the pieces of cheese from maintaining sufficient contact for a sufficient time to allow them to adhere to each other.) Manufacturers should keep in mind that where cheese pieces are touching they are much less likely to develop a sufficient skin during the dehydration process, so efforts should be made to avoid allowing the pieces to stick together.

“Puffing,” as used herein, means expansion of a product (e.g., one or more pieces of cheese, pieces of cheese to which inclusions, flavorings, etc., have been added, etc.) by the addition of heat. In the method of the invention, puffing is achieved using dielectric heating. Microwave heating is a more commonly recognized form of dielectric heating, and the term “microwave” is used herein as a non-exclusive option for dielectric heating. Those of skill in the art will recognize that the more recently-developed form of dielectric heating, radio frequency heating, can also be used to produce the puffing effect when applied to the cheese dehydrated to produce the surface skin. Suitable microwave heating systems, for example, are commercially available. One such system is the AMTek Microwave MWO4812R, a continuous microwaving system that offers the option of large-scale processing of puffed cheese products.

“At least one cheese” is used to produce puffs in the method of the invention, and the term “cheese” should be broadly construed to include cheeses made according to the standards of identity found in 21 CFR Chapter 1, Subchapter B, Part 133, as well as cheese-like products made by methods that fall outside the standard cheesemaking process as identified in 21 CFR 133 but which include sufficient ingredients from milk (particularly casein) to produce a product having a desirable taste and the appropriate textural properties (e.g., casein network) to form a suitable skin on the surface of a piece of the cheese-like product when dehydrated under the appropriate conditions as described herein. In its various aspects, the method can be used to make cheese puffs from at least one cheese selected from the group consisting of full, partial, and low-fat Cheddar, Colby, Monterrey Jack, Provolone, Mozzarella, Gouda, Swiss, Havarti, etc., and combinations thereof. “Cheese” can also include cheese curds. “Reduced-fat cheese”, as used therein, is intended to refer to a cheese having a fat content of from about 0 to about 25% fat. Furthermore, in various aspects, the cheese or cheese-like product used as a starting material for puffs can also comprise inclusions and/or coatings such as vegetable powders, seasoning blends, herbs, peppers, etc. Once formed into puffs, suitable/desirable coatings could optionally be added. The invention also provides puffed cheese products comprising at least about 50 percent natural cheese, the product(s) having a water activity in the range of from about 0.15 to about 0.80.

Aspects of the invention also provide a method for making puffed cheese snacks comprising the steps of forming at least one cheese into cheese pieces having a thickness of from about 0.5 mm to about 3 inches, dehydrating the cheese pieces by convection heating at a dehydration temperature of from about 65 to about 170 degrees Fahrenheit for a time period of from about 10 minutes to about 8 hours to produce dehydrated cheese pieces, and puffing the dehydrated cheese pieces using microwave heating to form cheese puffs. In various aspects, the dehydration temperature is, for example, from about 80 degrees Fahrenheit to about 150 degrees Fahrenheit. In various aspects, the dielectric heating temperature is from about 150 degrees Fahrenheit to about 500 degrees Fahrenheit.

The invention also provides a method for making puffed cheese snacks comprising the steps of forming at least one cheese into cheese pieces having a thickness of from about 0.5 mm to about 3 inches, dehydrating the cheese pieces by holding the cheese pieces at room temperature for a time period of from about 4 hours to about 96 hours, and puffing the dehydrated cheese pieces using dielectric (e.g., microwave) heating to form cheese puffs.

In various aspects of the method, the cheese pieces can comprise at least one shape selected from the group consisting of cubes, cuboids, spheres, ellipsoids, cylinders, cones, triangular prisms, hexagonal prisms, triangular-based pyramids, hexagonal pyramids, pentagrammic prisms, icosahedrons, octahedrons, dodecahedrons, and combinations thereof. In various aspects of the method, the step of puffing the dehydrated cheese pieces can optionally be performed in a negative pressure environment in combination with dielectric heating such as high temperature microwave cooking or radio frequency (RF) heating. Cheeses of from 32% moisture to 55% moisture are particularly useful as starting material(s) in the method of the invention.

Hot air heating functions by the application of heat at the product surface, so the heat must penetrate the material from the surface. This approach can be used in the dehydration step, because it produces a “falling rate period” during which the drying efficiency decreases because the dried product surface yields a layer with high heat and mass transfer resistance, with the temperature gradient generally in the opposite direction of the moisture gradient. The inventors use the hot-air heating step as a preferred option for creating the layer with high heat and mass transfer resistance, forming a “skin” on the surface of the cheese, although very acceptable results can also be obtained by dehydrating the cheese pieces using room temperature air convection.

Dielectric heating heats throughout the product, rather than unevenly heating from the surface. Dielectric heating uses electromagnetic waves and fields of varying frequencies to produce relatively uniform heating. Two forms of dielectric heating, for example, are microwave heating and radio frequency heating, microwave heating using a magnetron power source and radio frequency heating using a solid-state power source. Dielectric heating such as microwave heating is important in the step of puffing the dehydrated cheese pieces, because the energy heats the interior of a food product to build up an internal vapor pressure that drives moisture out of the cheese, the shape of each resulting puff being constrained by the presence of the skin on the surface of the pre-shaped cheese piece, thereby creating a puffed cheese product that can be made entirely of cheese, cheese with inclusions, cheese with added flavorings, etc.—but does not require the use of a carbohydrate matrix to create the puff. By first developing the skin on the surface of the cheese pieces in the dehydration, the melting bubbling cheese produced by dielectric heating is contained within each cheese piece during the puffing process until enough moisture is lost that it solidifies into a unique crumb structure that is typically only seen in carbohydrate-based products.

When popcorn pops, for example, it does so because moisture is trapped inside the kernel by the outer shell, or pericarp, which is made primarily of cellulose. The starch inside the kernel becomes soft and gelatinous when sufficient heat is applied, and the moisture vaporizes until the pressure in the kernel reaches about 135 pounds per square inch, at which point the pericarp ruptures and the gelatinized starch granules expand and solidify to produce the characteristic puff. However, popcorn popping relies on the combination of starch and cellulose—the popcorn kernel forming a two-component system that can be utilized to create the puffed product recognized as popped corn. The inventors have discovered a way to create a two-component system in a piece of cheese (i.e., a denser, drier covering over an interior containing sufficient moisture to create the steam necessary to expand the puff), using the sequential application of two different forms of heating which can be utilized to produce a cheese puff in a similar manner to that which creates a piece of popped corn.

Without the dehydration step, a “skin” is not created on the surface of the cheese, resulting in a product that is often uneven, has a coarse mouthfeel, and has a “bubbly” surface texture, a natural effect of cheese melting and then hardening again. The present method creates a strong enough exterior on the piece of cheese to contain the melting and bubbling during microwave heating so that the bubbles do not burst through the surface to deform the shape. However, although the skin provides the needed containment for the cheese as it undergoes the dielectric heating step, in the method of the invention it also produces a delicately crunchy, smoother surface than that produced by current commercial or home methods, which can result in an unacceptable level of crispiness/crunchiness and hardness.

Without the production of the skin over the surface of the cheese, creating a puffed product generally requires the application of negative pressure (i.e., a vacuum) while the cheese is being heated in order to promote the puffing effect. The creation of a skin, or thicker layer, on the surface of the cheese aids in promoting puffing during microwave heating without requiring a vacuum to allow for cooking at lower temperatures to prevent melting of the cheese during the moisture removal and puffing process. In fact, higher temperatures are important in the method of the invention, as the melting cheese in the interior of the puff is forms the unique crumb structure. However, one of skill in the art might choose to add a mild vacuum to either step of the method of the invention, provided that it is intended for moisture control or other uses, rather than for any significant reduction in microwave cook temperature. Creation of the thicker, drier surface (skin) also accomplishes an additional goal--that of producing a smoother, more even surface on the puffed cheese (because the melting cheese in the interior is contained until it solidifies), decreasing or eliminating the sharp edges that may be formed using a microwave/vacuum combination, and generally producing a more pleasant mouthfeel.

The dehydration step plays a significant role in how the cheese will puff without melting at higher heat. Dehydration promotes even crumb structure in the interior of the puff that gives it crunchiness without being too hard.

Because the melting cheese in the middle is contained by the skin, it creates bubbles in a contained space, thus creating a crumb structure that results in a light, pleasant crunch, rather than a hard or excessively brittle puffed cheese product. Various properties of the cheese pieces used to form puffs can be modified by a manufacturer to impact the development of the skin on the outside of the cheese pieces. For example, the dimensions and shapes of the cheese pieces (particularly thickness) can be modified to increase or decrease the amount of surface area covered by the skin and the type of product that is produced—such as puffs, pillows, puffed sticks, crispy puffed bars, puffed stars, triangles, etc. The development of the skin on the surface of the cheese, as well as the amount of moisture left in the interior of an individual piece of cheese, can depend upon the cheese type (e.g. reduced fat cheddar vs regular cheddar), the time of dehydration (e.g., 10 minutes to 24 hours), and/or the dehydration temperature (e.g., 75° F. to 175° F.). The information provided herein therefore provides one of skill in the art with multiple options for producing cheese snacks according to the method of the invention.

Most cheeses or process cheese/heat-treated cheese having a base composition of 0-38% fat and 20-70% moisture can be dehydrated and microwaved at higher heat without requiring the use of a vacuum (i.e., without performing the microwave heating in a negative pressure environment) to create crunchy cheese puffs with smooth surface texture. The inventors have demonstrated that cheeses having a fat content of from about 14 to about 18 percent and a moisture content of from about 40 to about 46 percent perform especially well in this application due to minimal oiling off (resulting in less browning), minimal sticking of pieces, greater puffing capacity, and less required dehydration time for optimal puffing. The optimal water activity range for final puffs generally varies from about 0.40 to about 0.10.

As cheese ages and intact casein declines, the structure of the cheese may slowly weaken, resulting in cheese puffs that may have lower puffing capacities. Cheeses having intact casein levels of at least about 75 percent will generally provide the most puffing capacity and smoothest surface texture.

The method of the invention can also be performed by applying the two forms of heating with a storage time in-between (i.e., after dehydration has produced a suitable skin on the surface of the cheese pieces). For example, if a water activity of 0.65 or lower is achieved, the dried cheese is stable to be stored at non-refrigerated temperatures and puffed via microwaving at a later date. (The inventors have demonstrated that puffed cheese snacks can be produced from dehydrated cheese pieces stored for 1 year, for example.) This produces a shelf-stable product that could be sold with instructions for at-home cooking so that a consumer could simply place the dehydrated cheese into a microwave oven and produce the puffs in a home kitchen, dormitory room, office break room, etc. The pre-dried cheese can be formed in multiple shapes/formats, but will have a drier outer layer and an interior with a slightly higher moisture/water activity (Aw). The overall Aw of the dried cheese should be from about 0.30 to about 0.75.

Products made by the method of the invention can provide snack puffs, ingredients for trail mixes and similar snack mixes, salad toppings, toppings for casseroles, cheese straws, filled cheese straws, pet treats, keto substitutes for tortilla and other chips, etc. to give consumers a variety of options for incorporating cheese into their diets in more unconventional ways. The method can be used to produce snacks made of a single type of cheese, mixed types of cheese (Cheddar and Monterrey Jack, for example), etc. Cheese puffs of the invention can have added flavoring, coloring, small inclusions (e.g., pepper) and other similar ingredients which do not alter the composition of the pieces so that they are no longer made substantially of cheese.

Based on the inventors' various experiments, it appears that results can be optimized by, for example, using cheese having no detectable residual sugar by 2 months of age and a targeted fat dry basis (FDB) of from about 5 to about 40%. This cheese has a higher relative protein content, resulting in a very strong network of casein—the casein network of this type of cheese allowing the puff to expand in a way not demonstrated in any other 100% cheese product currently on the market and tested by the inventors. This high protein casein network also creates a uniquely uniform crumb structure and air incorporation in the resulting puffed cheese product, which gives it a delicate crunch. The lower fat content in the cheese also prevents the oiling-off of cheese fat when exposed to higher temperatures, extending the shelf life by minimizing rancid and oxidized flavor notes over time. As an added bonus, it also produces puffed cheese products that have reduced oils that can be transferred to the hands of a consumer.

The inventors have demonstrated that the use of a reduced-sugar/reduced-fat cheese provides a synergist benefit to give a final product that can be very light in color (e.g., white), with minimal browning and having a flavor that is lacking in browned/burned flavor notes. Their testing has demonstrated that the combination of both characteristics in the cheese starting material works together to create an exceptional product. This can be accomplished, for example, by using, as a starting material in the method of the invention, a cheese having no detectable residual sugar by 2 months of age and a reduced fat content with a targeted fat dry basis (FDB) of from about 5 to about 40% in the method of the present invention. Methods for producing reduced-sugar cheese are known to those of skill in the art of cheesemaking. Such methods can comprise, for example, pairing Gal(+) S. thermophilus isolates with Gal(−) L. delbrueckii subsp. bulgaricus isolates in the cheese culture during the cheesemaking process, or using enzymes to reduce the sugar content (see, for example, Soe, et al., U.S. Pat. No. 8,163,317).

Where the term “comprising” is used herein, it should be understood that the terms “consisting of” or “consisting essentially of” can be substituted when a narrower interpretation is intended and/or appropriate.

The invention can further be described by means of the following non-limiting examples.

### EXAMPLES

### Cheese Puff “Pillows”

Natural cheese was sliced into 2 cm×2 cm×2 mm squares and placed in a dehydrator at 131° F. to produce cheese with the desired water activity before being microwaved for one minute. When cheese slices were microwaved without dehydration (water activity of the cheese slices 0.95-0.97), they had a bubbly, but rough texture. A 30-minute dehydration step (resulting in a 0.92 water activity in the slices) decreased the amount of surface/exterior roughness in the puffed cheese, and a water activity of 0.80-0.90 (achieved by dehydrating the puffs from 1.5 hours to 3.5 hours) was optimal for developing cheese puff pillows that had a smooth and shiny exterior with a porous center. When dehydrated to water activities that were under 0.80, puffs were generally flatter, and more cracker-like in appearance.

### Puffed Cheese Sticks

Natural cheese was sliced into 2 mm thick slices, then the slices were cut into sticks that were 3.5 cm or 1.75 cm wide, with varying lengths. Cheese was dehydrated at 131° F. for 1.5 hours and then microwaved for 1.0-1.25 minutes, resulting in a puffed cheese stick. When dehydrated under these conditions, the sticks were hollow, which could allow a filling to be incorporated into the puffed cheese sticks.

The hollowness of the puffed sticks was impacted by the dehydration level as well as the slice thickness. When dehydrated for a longer period of time before being microwaved, the sticks were flatter, with a more porous center. A similar result was observed when thinner slices were used.

### Cheese Puff “Bars”

Natural cheese slices that were 2 mm thick were cut into bar sizes (2 inches by 3 inches) and were dehydrated at 158° F. before being microwaved. When cheese slices were microwaved without drying/dehydration, the cheese would bubble and melt during microwaving, resulting in a coarse texture. However, after an hour of dehydration, the slices puffed well and had big pockets of air in the middle. With two to five hours of dehydration, the cheese slices puffed to produce flatter bars.

### Cheese Puff “Chips”

Natural cheese slices, 2 mm thick, were cut into triangles and dehydrated at 158° F. for 4.5 hours. When microwaved, the cheese puffed only slightly due the amount of water that had been lost during the dehydration process, resulting in a texture and appearance very similar to a tortilla chip.

### Cheese Puff “Popcorn”

Natural cheese was cubed into small pieces ranging from ⅛ in. by ⅛ in. to ½ in. by ½ in. cubes. Cubes were dehydrated for times ranging between 0.5 hours to 8 hours at temperatures ranging from 112° F.-158° F., depending on the size of the cube. When the cubes were microwaved between 1.0-2.0 minutes, they puffed into kernels similar to popcorn. The shape of the kernels was controlled by the size of the cubes, as well as the level of dehydration achieved prior to microwaving.

### Cheese Puff “Crispies”

Natural cheese was diced into very small pieces/cubes. These small pieces were dehydrated to a water activity ranging between 0.60-0.95 and puffed to make a small protein crisp similar in texture to a crisped rice product such as Kellogg's Rice Krispies®. These small crisps are suitable for incorporation into bars or other applications where clean label, crunchy protein ingredients are desired.

### Cheese Puff “Straws”

Natural cheese was shredded and dehydrated for 0.5 hours to 8 hours. When microwaved at times ranging between 30 seconds to 1 minute, the dehydrated shreds puffed into little straws that could be used in a number of applications such as crunchy topping for casseroles/salads, etc.

### Shaped Cheese Puffs

Natural cheese was sliced to 2 mm thickness and a cutter was used to form the cheese slice into a specific shape. Shapes could also be created using an extruder with various types of dies. When the shaped cheese slices were dehydrated for two hours and microwaved for 1 minute, not only did they puff well, but they retained their shape very clearly, making this an attractive way to make a 100% cheese snack with varying shapes, demonstrating that the formation of the skin at the surface enables puffing without deformation.

Cheese Powder from Puffed Cheese Products

Puffs made as described above were milled, or placed in a blender, to create a 100% clean label cheese powder.

What is claimed is:

1. A method for making puffed cheese snacks, the method comprising the steps of:
a) forming at least one cheese into cheese pieces having a thickness of from about 0.5 mm to about 3 inches;
b) dehydrating the cheese pieces to form cheese pieces having a water activity of from about 0.30 to about 0.95; and
c) heating the dehydrated cheese pieces using dielectric heating to produce puffing of the cheese pieces to form cheese puffs.

2. The method of claim 1 wherein the step of dehydrating the cheese pieces produces cheese pieces with a moisture gradient decreasing from the inside to the outside of the cheese pieces and a resulting skin covering the surface of each cheese piece.

3. The method of claim 1 wherein the step (b) of dehydrating the cheese pieces is performed as a two-stage process, with stage 1 being the formation of a skin to coat each cheese piece while lower temperatures are used to remove moisture and frequent handling prevents the cheese pieces from adhering to each other, and stage 2 being a further dehydration period at higher temperatures to achieve target moistures, water activities, and skin thicknesses.

4. The method of claim 1 wherein the dielectric heating is microwave heating.

5. The method of claim 1 wherein the dielectric heating is radio frequency heating.

6. The method of claim 1 wherein the cheese pieces can comprise at least one shape selected from the group consisting of animal shapes, stars, shapes of commonly identifiable objects, cubes, cuboids, spheres, ellipsoids, cylinders, cones, triangular prisms, hexagonal prisms, triangular-based pyramids, hexagonal pyramids, pentagrammic prisms, icosahedrons, octahedrons, dodecahedrons, and combinations thereof.

7. The method of claim 1 wherein the at least one cheese is selected from the group consisting of full, partial, and low-fat Cheddar, Colby, Monterrey Jack, Provolone, Mozzarella, Gouda, Swiss, Havarti, and combinations thereof.

8. The method of claim 1 wherein the cheese puffs further comprise one or more inclusions.

9. The method of claim 1 wherein the cheese puffs further comprise one or more coatings.

10. The method of claim 1 wherein the at least one cheese is a cheese having no detectable residual sugar by 2 months of age and a reduced fat content with a targeted fat dry basis (FDB) of from about 5 to about 40%.

11. The method of claim 1 wherein the step of milling the cheese puffs is added to produce cheese powder from the cheese puffs.

12. A method for making puffed cheese snacks comprising the steps of
a) forming at least one cheese into cheese pieces having a thickness of from about 0.5 mm to about 3 inches;
b) dehydrating the cheese pieces by convection heating at a dehydration temperature of from about 65 to about 170 degrees Fahrenheit for a time period of from about 10 minutes to about 8 hours; and
c) puffing the dehydrated cheese pieces using dielectric heating to form cheese puffs.

13. The method of claim 12 wherein the dehydration temperature is from about 80 degrees Fahrenheit to about 170 degrees Fahrenheit.

14. The method of claim 12 wherein the dehydration temperature is from about 90 degrees Fahrenheit to about 150 degrees Fahrenheit.

15. A method for making puffed cheese snacks comprising the steps of
a) forming at least one cheese into cheese pieces having a thickness of from about 0.5 mm to about 3 inches;
b) dehydrating the pieces of cheese by holding the cheese at room temperature for a time period of from about 4 hours to about 96 hours; and
c) heating the dehydrated cheese pieces using microwave heating to form cheese puffs.

16. A puffed cheese product comprising at least about 50 percent natural cheese, the product having a water activity in the range of from about 0.15 to about 0.80 and a fat content with a targeted fat dry basis (FDB) of from about 5 to about 40%.
